(19) United States
(12) Patent Application Publication
(10) Pub. No.: US 2010/0010688 A1
(43) Pub. Date: Jan. 14, 2010

(54) Energy monitoring and management

(76) Inventor: Robert R. Hunter, Danville, CA (US)

Correspondence Address: Derek J. Westberg;Westberg Law Offices, Ste. 530, 569 Clyde Ave., Mountain View, CA, 94043, US

(21) Appl. No.: 12/217,786

(22) Filed: Jul. 8, 2008

(51) Int. Cl. G05D 23/19; G06F 1/32; G06F 1/28; G06F 15/16; G06F 9/46

(52) U.S. Cl. 700/300; 713/320; 700/299; 713/340; 709/238; 718/104

(57) ABSTRACT

A method of controlling energy use in a system comprising a plurality of computing resources arranged in at least one computing device is described. The method includes: defining a desired heat profile for a computing device which optimises airflow characteristics for the computing device; monitoring the energy use of at lease one computing resource; determining the heat generation of each computing resource at least partly on the basis of the energy use of the computing resource; and controlling the operation of one or more computing resources so that the heat generation of the computing device is optimised towards the desired heat profile.

### FIELD OF THE INVENTION

The present invention relates to energy monitoring and management within a computer room environment.

### BACKGROUND OF THE INVENTION

Data center heat density has been increasing since the advent of the server. This has become particularly problematic during the past few years as data center managers have struggled to cope with heat and energy intensity problems. These issues have resulted in enormous energy bills and a rising carbon impact.

In the past it has been customary to use only fixed cooling assets to try to address a dynamic heat load. This has created inherent inefficiencies.

Computer servers are energized by CPU chips whose advance in capabilities are generally described through Moore's Law. Moore's Law states, the number of transistors on a chip will double every two years. This law has been much debated over the past few years but, however in general it has proved remarkably prescient. Consequent upon the increase in the density of transistors in microprocessors, energy consumption in these devices has increased dramatically. In this regard, the general trend is for maximum energy consumption to increase a little more than 2 times every 4 years. Much of the engineering resources used by chip manufacturers today are spent tackling this energy consumption and a related heat dissipation challenge.

Whilst the decrease in size of the transistors in modern microprocessors is essential for increases in computing energy it brings in additional challenges, most notably in terms of variations within cross sections of circuitry among otherwise identical chips.

In a multi-core architecture, each core forms a separate processing zone. It has been shown that in multi-core chips asymmetry between any two cores leads to differences in wattage drawn by a chip to perform the same task.

FIG. 1 depicts the effect of variability on wattage within the first-generation dual-core Itanium processor (Montecito) running a single task repetitively. As this graph shows, the energy consumption in watts has a range of around ±8% ftor the mean while running the same task. This illustrates the fact that a single chip will use differing amounts of energy to accomplish the same process.

A second area of chip variability occurs between any two chips made with the same die. This is known as With-in Die (WID) variability. WID variability, has been studied with great detail over the past few years as nano-scale architectures have moved to new levels. Studies have shown that wattage variability for chips produced on one die can have standard deviations of ±10% from the mean. That is, 68% of the chips in the same die would have an average wattage draw that falls within a range of 20% from top to bottom. For the second sigma group of 27%, one can expect a energy range of 40% and so on. Such a high range of energy consumption is far beyond what many have come to expect and it creates new management challenges.

There is a third class of chip variability which is know as the Inter-die variation. Whilst there is no public information concerning inter-die variations one expects that two chips from different dies would appear to have a likelihood of producing a greater variation than those that come from a common die.

In addition to the energy consumption variation between any two identical chips, energy variations arise from the natural change in tasks performed by a processor during a day. Processor usage may go from an idle position for at least some time of the day towards a full load at other times. The variation of energy usage between identical chips coupled with the natural variation of work load provides an extremely dynamic heat profile for each server.

The rise in magnitude and variability of heat loads of CPU's, memory chips and the computer equipment in which they are employed creates enormous strains on data center cooling infrastructure. These strains create heat problems that manifest themselves as hot spots, hot zones, tripped breakers and other density-related issues as well as rising cooling use and consequent cost and carbon impact.

Adjusting the air flow under floor, above floor or within a cabinet is a primary practice to provide more cooling to server racks and cabinets that are running at high heat levels. Adding additional air flow can offer help in some cases but at a very high price of extra energy usage. Air flow must increase at an exponential rate in order to dissipate an arithmetic rise in heat load. This means that the energy consumption to generate higher fan flow rates increases at an exponential rate as well.

In the past few years, The Green Grid and other organizations have proposed using standardized measurement metrics for overall data center energy efficiency. The specifics of the metrics offered by the Green Grid are centered around wattage data and include:
Power Usage Effectiveness (PUE):
   Total Data Center Energy use/IT Equipment Energy use.
Data Center Efficiency (DCE), which is the inverse of PUE or;
   IT Equipment Energy use/Total Data Center Energy use

Total Data Center Energy use includes contributions from the following:
IT equipment—servers, storage, network equipment, etc
Cooling Load—Chillers, CRAC (Computer Room Air Conditioners)
Electrical losses associated with the PDU (Power Distribution Units), UPS (Uninterruptible Power Supplies) and Switchgear systems.

According to the Green Grid, most data centers have a PUE of over 3, yet a number of less than 1.6 has been shown to be achievable. As will be appreciated, in a data center having a PUE of 3, the energy used for cooling the data centre will most likely exceed the IT equipment energy plus electrical losses.

In view of the foregoing it can be seen that there is a need to address the energy usage in computing and data center environments.

### SUMMARY OF THE INVENTION

In a first aspect the present invention provides a system for monitoring and controlling power consumption in a computer device comprising a plurality of computing resources. The system includes: at least one automatic energy monitor adapted to measure energy use of the computing resources; a computer system for receiving a signal indicative of a measured energy use of each computing resource measured by the energy monitor and determine a level energy consumed by each computing resource; a controller configured to control the operation of said plurality of computing resources so as to minimise the difference in energy use between the plurality of computer resources comprising the computer system.

The computer system can determine which computing resource are consuming power and the rate of consumption of power.

The controller can enable manual or automatic management the rate of power consumption.

In a preferred form of the invention the energy use of each computing resource is monitored by a dedicated automatic energy monitor. Groups of computing resources can be monitored by a common automatic energy monitor.

The controller can be configured to minimise the difference in energy use between the plurality of computer resources by controlling the processes running on each computing device. Control can be performed remotely.

In a second aspect the present invention provides a system for monitoring and controlling power consumption in a system comprising a computer device including a plurality of computing resources and at least one cooling device for cooling the computing device. The system includes: at least one automatic energy monitor adapted to measure energy use of the computing resources and the cooling device; a computer system for receiving a signal indicative of a measured energy use of each computing resource and cooling device as measured by the energy monitor and to determine a level energy consumed by each computing resource and cooling device; a controller configured to control the operation of at least one of said computing resources and cooling devices to control the amount of cooling being used by each computing device at least partly on the basis of the measured energy use of at least one of said computing resources and cooling devices.

The controller can enable manual or automatic control of the operation of at least one of said computing resources and cooling devices to control the amount of cooling being used by each computing device. Preferably the controller enables manual or automatic control of the operation of at least one of said computing resources and cooling devices to match the rate of cooling to the energy consumption of each computer device.

In a third aspect the present invention provides a method of controlling energy use in a system comprising a plurality of computing resources arranged in at least one computing device. The method includes: defining a desired heat profile for a computing device which optimises airflow characteristics for the computing device; monitoring the energy use of at lease one computing resource; determining the heat generation of each computing resource at least partly on the basis of the energy use of the computing resource; and controlling the operation of one or more computing resources so that the heat generation of the computing device is optimised towards the desired heat profile.

The system can include an air conditioning system, having one or more air conditioning resources, for cooling at least one computing device. In this case the method can further include: controlling the operation of at least one air conditioning resource on the basis of the energy use of at least one computing resource.

Preferably the method includes: monitoring the energy use of at least one air conditioning resource; and adjusting the operation of one or more computing resources so that the energy use of at least one air conditioning resource is minimised.

The step of controlling the operation of one or more computing resources so that the heat generation of the computing device is optimised towards the desired heat profile preferably includes, controlling the operation of one or more computing resources so that electric energy flowing through a circuit powering at least two computing resources of the computing device is substantially equal.

The step of controlling the operation of one or more computing resources can include moving at least one of a processes; a process thread; and a virtualized process or a virtual server from one computing resource to another.

The step of controlling the operation of one or more computing resources can include selectively routing network traffic to a computing resource.

Controlling the operation of at least one air conditioning resource can include any one or more of the following: selectively redirecting airflow from an air conditioning resource to cool a computing device; adjusting an airflow level output by an air conditioning resource; adjusting a temperature of cooling air output by an air conditioning resource.

In a fourth aspect the present invention provides a method of controlling an air conditioning system configured to cool at least one computing resource arranged in at least one computing device. The method includes: defining a desired heat profile for a computing device which optimises airflow characteristics for the computing device; monitoring the energy use of a computing resource; determining the heat generation of each of the computing resources on the basis of the energy use of the computing resource; and controlling the operation of at least one air conditioning resource on the basis of the energy use of at least one computing resource of the computing device.

The method can include: monitoring the energy use of at least one air conditioning resource; and adjusting the operation of one or more computing resources so that the energy use of at least one air conditioning resource is minimised.

The method can include associating one or more air conditioning resources to a plurality of computing resources; and adjusting the heat removal capacity of the one or more air conditioning resources to substantially match the energy use of the computing resources with which it is associated.

In certain embodiments the heat profile for a computing device includes one or more of: a spatial temperature profile for the device, a spatial temperature variation profile; and a temporal temperature variation profile.

Preferably the energy use of, one or both of, an air conditioning resource or computing resource is monitored on an electrical circuit powering the resource. The method can include measuring any one or more of the following parameters of the electrical circuit: electric energy flowing through the circuit; electric energy that has flowed through the circuit in a given time; voltage across the circuit; current flowing through the circuit.

Preferably the temperature profile is substantially spatially uniform.

The method can include: selectively redirecting airflow from an air conditioning resource to cool a computing device; adjusting an airflow level output by an air conditioning resource; adjusting a temperature of cooling air output by an air conditioning resource.

In a further aspect the present invention provides a computing system comprising a plurality of computing resources arranged in at least one computing device: at least one automatic energy monitor adapted to measure at least one electrical parameter of a circuit powering a computing resource of the computing device; a data acquisition sub-system for receiving a signal indicative of a measured energy parameter of the circuit powering each computing resource measured by the energy monitor; and a controller configured to determine a level of heat generated by each computing resource on the basis of the measured electrical parameter and to control the operation of one or more computing resources so that the heat generation of the computing device is optimised towards a desired heat profile for the computing device.

The system can further include: an air conditioning system, including one or more air conditioning resources, for cooling said at least one computing device, and wherein the controller is further configured enable the operation of at least one air conditioning resource to be controlled on the basis of a measured electrical parameter of a circuit powering at least one computing resource of the computing device.

The system preferably also includes: at least one automatic energy monitor adapted to measure at least one electrical parameter of a circuit powering an air conditioning resource of the system, and the data acquisition sub-system can be further adapted to receive a signal indicative of said measured electrical parameter of the air conditioning resource.

The heat profile for a computing device is preferably chosen to optimise airflow to the computing device.

Preferably the controller controls the operation of one or more computing resources so that electric energy flowing through a circuit powering at least two computing resources of the computing device is substantially equal.

In a further aspect the present invention provides a method of distributing computing tasks between a plurality of computer resources forming at least one computer device The method includes; defining a desired heat profile for a computing device to optimise airflow associated with the computer device; determining the heat generation of each computing resource on the basis of the computing resource's energy use; and adjusting the heat being generated by at least one of the plurality of computer resources to optimise the heat being generated by the computer device towards the desired heat profile by distributing computing tasks to at least one of the plurality of computer resources. The method can include distributing least one of the following computing types of tasks: a processes; a process thread; and virtual server. Distributing computing tasks can include selectively routing network traffic to a computing resource.

The step of distributing computing tasks to at least one of the plurality of computer resources preferably includes controlling the operation of one or more computing resources so that electric energy flowing through a circuit powering at least two computing resources of the computing device is substantially equal.

In a further aspect the present invention provides a scheduling scheme for distributing computing tasks between a plurality of computing resources of at least one computing device, said scheme being defined by a plurality of task distribution criteria relating to one or more, task characteristics or computer device characteristics, wherein at least one of the task distribution criteria is at least partly based on the heat being generated by a plurality of the computing resources. The scheme for distributing computing tasks can include task distribution criteria based upon heat value of a computing resource which is determined on the basis of a measurement of energy used by the computing resource.

In yet another aspect the present invention provides a method of arranging one or more computing resources within a computing device forming part of a computing system. The method includes; defining a plurality of energy consumption classes and classifying the computing resources into at least one class; defining a desired heat profile for at least part of the computing device on the basis of the energy consumption classes, said desired heat profile being configured to optimise airflow associated with the computing device; arranging the computing resources within the computing device to optimise heat generated within the computing device towards the desired heating profile.

Preferably the computing device is a server rack and the computing resources are servers mounted within the rack. The computing system can be a server room or data centre and the computing resources include one or more servers or other computing or network appliances.

The invention can also provide a computing appliance configured to schedule computing tasks between a plurality of computer resources or network devices, in accordance with an embodiment of the above mentioned methods.

In a further aspect the present invention also provides a computer program comprising a set of computer implementable instructions that when implemented cause a computer to implement a method according to the invention. A computer readable medium storing such a computer program forms another aspect of the invention.

### BRIEF DESCRIPTION OF THE DRAWINGS

Preferred forms of the present invention will now be described, by way of non-limiting example only, with reference to the accompanying drawings, in which:

FIG. 1 depicts the effect of variability on wattage within the first-generation dual-core Itanium processor (Montecito) running a single task repetitively;

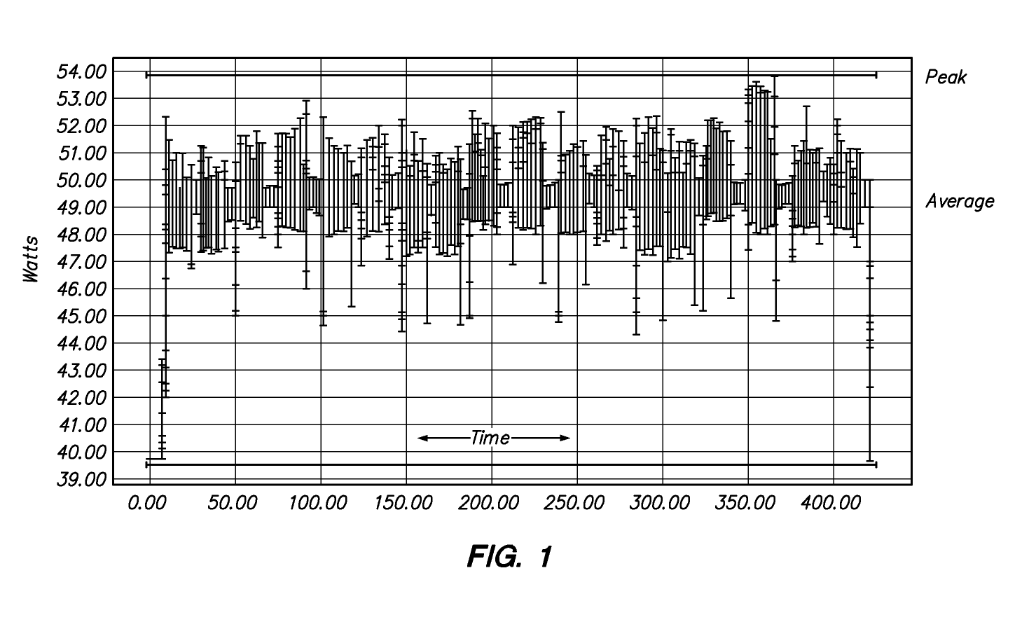

FIG. 2 illustrates an exemplary server cabinet and an equivalent circuit representation of the server;

FIG. 3 illustrates schematically a computer equipment room, and illustrates an environment in which an embodiment of the present invention can be implemented;

FIG. 4 illustrates schematically a computer equipment room, including energy usage monitoring equipment according to an embodiment of the present invention;

FIG. 5 illustrates a server room having a cooling system operable in accordance with a preferred embodiment of the present invention;

FIG. 6 illustrates a second example of a server room having a cooling system operable in accordance with a preferred embodiment of the present invention; and

FIG. 7 illustrates a another exemplary server room having a cooling system operable in accordance with a preferred embodiment of the present invention.

### DETAILED DESCRIPTION OF THE EMBODIMENTS

The present inventors have had the insight that the units of measurement of CPU energy, heat and total energy used by a microprocessor are integrally related. Most specifically, the energy that a CPU draws in watts, is exactly the same as the heat in watts it radiates. That is, energy draw and heat load are simply two sides of the same coin.

Moreover, the present inventors have realised that energy use and carbon impact can be reduced by managing heat generation characteristics within the computing environment which leads to the ability to better utilise the cooling resources available. Preferably this is achieved by actively managing the following factors.
variation of heat generation within a group of computer resources;
matching of cooling resources to the heat loads generated.

Turning firstly to the problem of heat variation within a group of computer resources, the inventors have identified that one of the key heat generation characteristics of a group of computing resources, e.g. servers within a server cabinet, is the variability of heat load between servers. In particular, it has been found that it is advantageous to hold the total variation of energy use, and consequently heat generation, between individual or groups of computer resources (e.g. servers within a rack) to a minimum. This can have a three fold benefit—firstly, it minimizes the energy needed to cool the computing resources within their enclosure because it presents advantageous airflow resistance characteristics, next it minimises the need to deal with sharp increases and variations in temperature which reduce equipment life and increase equipment failures, and third it minimises heat recirculation and therefore hotspots within a given space for a given level of processing.

In fact, in a preferred form of the invention, minimising the difference in heat generation between servers or groups of servers within a cabinet or rack provides more improvement in cooling performance within a cabinet than the varying the total heat load of the cabinet. For instance it has been found that a cabinet with a balanced heat load throughout it can support 50% more total heat, and thus, 50% more equipment load than the equivalent cabinet having servers distributed with random heat levels. Such a cabinet will also exhibits far less temperature variation with time (better than 20% improvement) which further adds to overall energy efficiency of the computer room.

In a preferred foil of the invention the heat variation tolerance within a group of servers should be held to 20% or, the maximum expectation for the average spread of 1 standard deviation of CPUs within the group of servers.

In an ideal system one would measure the heat generation and variation of each server individually and balance their use accordingly. However, generally speaking it is not practical to do this, therefore is useful to group servers into at least two groups within a rack or cabinet and to balance heat loads of one group of servers vs another.

The following three classifications are used:
low load—these servers are most often in a low load or idle position and any processing creates large jumps in energy use and heat levels;
medium load—these servers spend the majority of time above idle but, at less than 80% capacity; and
a high load—these servers spend the majority of the time above 50% capacity.

It is possible to use these loading classes as a predictor of variance in heat generation as follows:

Loading

| | Low | Medium | High |
|---|---|---|---|
| Variability of heat output | High | Medium | Low |

Therefore to minimise overall heat variation in a cabinet or within a portion of a cabinet, high load physical servers are preferably grouped together. Similarly, medium load physical servers should also be grouped.

From the table above it will be appreciated that a cabinet of only low loaded servers may present a rather chaotic heat output over time and potentially create significant hot spots. Therefore, low load physical servers are preferably interspersed amongst high and medium load servers. This arrangement minimises the variation of heat load within each cabinet or portion of a cabinet.

Virtualized servers have a low standard deviation heat load profile. This fact can be put to use both by grouping virtual servers within their own cabinets or, by using the relative heat stability of virtual servers to mitigate the heat variations of servers with lighter loads and higher heat standard deviations. If used properly, this factor can provide significant energy efficiency benefits and may present a reason to move servers that have not yet been virtualized to a virtual position.

In addition to the inherent benefits of the higher loading factors of virtual servers compared to low load servers, with virtual servers load balancing tools can be used shift computing tasks to achieve energy efficiency benefits. For example, user can schedule and, in some cases, move applications on-the-fly to change processor wattage and thus, improve heat load balancing in a cabinet or rack. This balancing reduces hot zones and total air resistance and therefore lowers cabinet or rack temperature and consequently reduces cooling needed in the rack. This balancing results in an increase in data center energy efficiency.

Alternatively the dynamic arrangement of servers can be done in a non-virtualized environment as well. For non-virtualized environments, these tools that can be used to change server loading include load balancing switches, routers and hubs, which can be used to choose which server will handle a specific request. Any device which can be used to change the loading of a CPU, memory, disk system, server, computing equipment, group of computing equipment or network and may be made responsive to heat loading data for such devices, could be used to balance heat load among computing devices, thus, providing less temperature variation and better air flow characteristics and therefore reducing cooling requirements while increasing data center efficiency.

To assist in the understanding of the energy use and consequently heat minimisation implications of this aspect of the present invention, it is useful to consider that each server (or group of servers) in a system can be seen to act as if it were a resistor. Thus the overall system of servers can be represented electrically as a system of parallel resistors, wherein each server (or group of servers) is represented by a resistor having some equivalent input impedance.

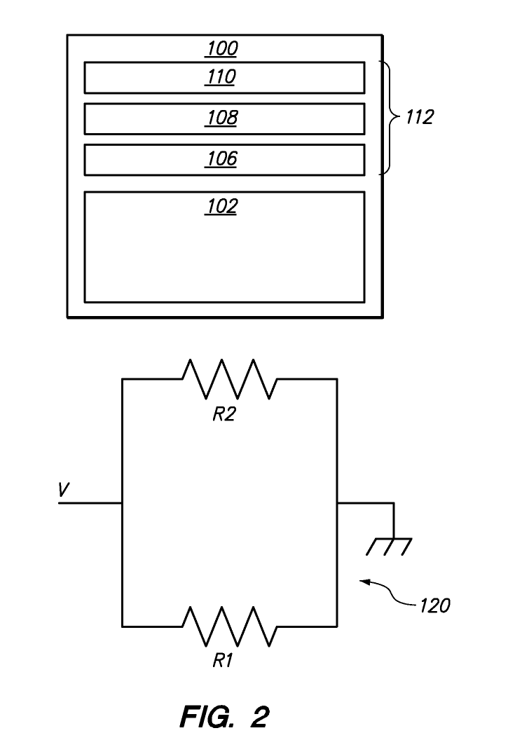

For example FIG. 2 illustrates a server cabinet 100 including four servers 102 to 110. This server cabinet can be modelled as a circuit 120 in which server 102 is modelled as resistor R1 and the group of servers 106, 108 and 110 are modelled as resistor R2. As will be appreciated R2 is derived by treating the group of servers 112 as three parallel resistors and determining an equivalent resistance of the group 112.

At this point it is helpful to examine how the total energy used by such a set of parallel resistors varies with particular resistance values. Let's choose an example where resistor R1 has a resistance of 100 Ohms and resistor R2 has a resistance of 150 Ohms. When placed in parallel, the combination R1∥R2 has a resistance of (150*100)/(150+100)=15000/250=60 ohms.

Secondly, consider the case where resistor R1 has a resistance of 125 Ohms and resistor R2 has a resistance of 125 Ohms. The combination R1∥R2 has a resistance of (125*125)/(125÷125)=15625=62.5 ohms. Note that in both cases the sum of the component resistances, R1∥R2 is 250 Ohm. However, the observed parallel resistance varies depending on how the balance is shifted between the separate branches of the circuit.

Assuming a 110V energy supply was used to feed such a system of resistors, it is can be seen that a different amount of current must flow either of the parallel circuits described. In the first case, 110 Volts across a 60 ohm load results in a current of 1.83 amps. In turn, this implies a energy consumption of roughly 200 Watts.

In the second case, 110 Volts across a 62.5 ohm load results in a current of 1.76 amps. This implies a energy consumption of roughly 193.6 Watts.

In practice, R1 and R2 are electrical characteristics of a circuit and will each vary according to the characteristics of the servers, e.g. according to the physical characteristics of the processors involved, and the extent to which the processor is loaded at the instant of measurement. However, there is a link that can be established between the wattage of heat in a server and the thermal resistance of the air in a computer rack or cabinet.

It follows that balancing the manner in which resistance is presented to a source of energy can reduce the overall energy consumption. Using the “thermal resistance” analogue of Ohm's Law, we learn that:

Temperature Rise=Thermal Resistance×Power dissipated by the system

and therefore:

Thermal Resistance=Temperature Rise/power dissipated by the system and,

Power dissipated by the system=Temperature Rise/Thermal Resistance

It can be seen then, that by measuring and controlling any two of these three variables, one can control the outcome of the third. Further, because temperature is simply driven by energy use, we know that by equalizing energy use among computing equipment within a space that presents otherwise generally equal thermal resistance, it is possible to control temperature variations. This can reduce the cooling requirements for the equipment to a common temperature point. In an environment where energy use varies from one computer to another, it is still possible to reduce the difference in temperature from any piece of equipment to the next, or to form groups of equipment which have similar energy use and thus temperature ranges. Thus, even with computer equipment with different energy consumption for individual units, groups of computers can be combined to provide advantageous thermal and, thereby, cooling conditions.

Temperature, then, correlates strongly with the energy consumption within a circuit for computer racks and cabinets. Therefore, measuring and controlling energy consumption can provide the means to control temperature and, therefore, control the total amount of cooling necessary to mitigate the heat in a computer rack or cabinet.

While it would be ideal to measure both temperature and energy use for complete verification, it can be seen that it may not be necessary so long as energy use can be measured. However, in some cases, it may not be economically feasible to measure energy use. Therefore, a lower cost proxy may be used in such cases. For example, rather than measuring actual energy use, one may measure and control current (amperage) or amp hours. In the case of temperature, it may not be possible to measure temperature accurately in the computer equipment or CPU. Therefore, an alternative proxy could be used that may include cabinet or rack temperature, server case temperature, mother board temperature or other similar temperature points.

While the equalization of wattage between servers or groups of servers or other computing or electronic equipment in a cabinet or rack will allow for better air flow patterns and reduced cooling needs, it should also be noted that it may be possible to define a heat profile within a cabinet that maximises the cooling effectiveness within the cabinet, without uniform wattage or uniform resistance, as in the example of FIG. 2. In accordance with another embodiment of the invention, the processing load of the computing devices within the cabinet can still be managed even when wattages are significantly different between two or more devices, so that their energy consumption and/or the energy consumption needed to cool these devices approaches that defined by the desired heat profile. This may be accomplished by spreading out the servers with the highest loads in an equidistant fashion from one another. Preferably each high load (and therefore heat) server or group of servers are located on a separate circuit, so as to equalize the energy usage between circuits and hold resistance to as the most uniform and lowest level possible between groups of servers.

In practice, servers (e.g. a single piece of hardware as in a standard server or a single blade within a blade server) may be grouped so as to manage the resistance of groups of servers rather than individual servers. Primarily this is done for the sake of cost efficiency of reducing the number of measurement points. A group can be from 1 server to 100 or more servers in a single cabinet. Ideally, each group of servers can be contained within a single power circuit so as its total energy use can be measured, thus allowing it to be managed by its energy use (or a proxy of its power usage or temperature may alternatively be used). Thus, when it is not possible or feasible to monitor individual servers and their energy use, it may be possible to monitor and control the total amount of heat being generated by all servers attached to each circuit, within a cabinet or rack. It follows then that, in order to reduce the cooling requirements for such rack or cabinet that one would try to minimize the difference of wattage load for each circuit as compared to the other or others within that cabinet or rack.

Further, when it is not possible to monitor energy use for individual servers but, where energy use measurements may be taken for all servers on each circuit within a rack, a proxy for energy use or temperature measurement may be used for each individual server that is attached to a circuit. A proper proxy must vary in proportion to the energy usage of heat and, therefore, proper proxies may include: CPU Utilization, CPU amperage, CPU temperature, Motherboard amperage, Motherboard temperature or other such measurements as may be available which bear a relationship to the amount of energy being used by that processor.

It can be seen then, that, even if one can only measure energy use at the circuit level for groups of servers within a cabinet that it may still be possible to balance heat loads effectively among both, groups of servers, and individual servers within a group by varying the amount of processing done on each CPU of each server. A proxy for energy use can be measured and the differences in that proxy minimized between individual servers while, also minimizing the total energy use of all servers that are attached to each circuit, by comparing circuits within that cabinet.

In addition to the above, it can be seen that, when using circuit load measurements to balance groups of servers, it is most advantageous to physically place each server within a circuit group within the same physical zone of a cabinet or rack. For example, with a cabinet having 3 circuits A, B and C and each circuit having 10 servers attached, it is most advantageous from a management and control standpoint to place all 10 servers from circuit A in the lowest 10 spots within a cabinet, then to place all 10 servers attached to circuit B in a middle location within the cabinet and, finally, to place all 10 servers attached to circuit C in the top location within the cabinet. In this manner, it is both easier to keep track of computing resources and, to know the exact effect and location within a cabinet of the heat loading.

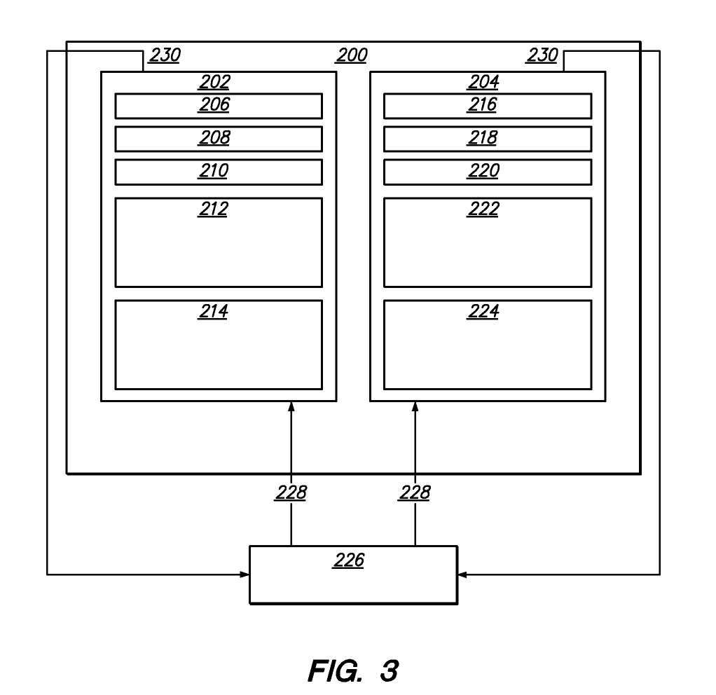

While heat balancing can achieve significant energy savings in terms of cooling requirements, lower carbon impact and increased equipment life, the inventors have seen that it may also be advantageous to match cooling levels of air or liquid to the heat levels that are being generated within any individual cabinet. FIG. 3 illustrates such a system schematically with a computing environment, which in this case is a computer server room 200. The server room 200 is illustrated as including two cabinets 202 and 204 housing a plurality of computing devices 206 to 224. Cooling of the cabinets is provided by a computer room air conditioner (CRAC) unit 226. The CRAC unit 226 provides cool air 228 into the cabinets 202, 204 to cool the computing devices 206 to 224 and draws heated air 230 from the room for cooling and recirculation. Those skilled in the art will be familiar with stick arrangements and methods and techniques for distributing air within such a computer the room.

To implement an embodiment of the present invention in such a system, the energy consumption of heat generation (and in some cases the temperature) of the computing devices within a cabinet or rack, needs to be monitored. Embodiments of the present invention can take such measurements for each device individually or in groups. In a particularly preferred form, energy consumption of the computing devices is measured in groups defined by the circuit to which the devices are collected. However, measurements of energy consumption may be taken at one of a number of positions, including but not limited to:
at the circuit level within a power panel for all servers on a circuit;
at the power strip level for all servers on a circuit;
at the plug level of a power strip for an individual server or blade server or similar multi-server module;
within the server at the CPU(s) or on the mother board or power supply.

Measurements of wattage preferably measure true RMS wattage, but a proxy for wattage may also be used, for example, by measuring amperage at any of the above points or by estimated using data from the CPU or motherboard as to its amperage or amperage and voltage.

Measurements of temperature may not need to be taken and may be assumed to be a relatively constant if wattage can be held to a reasonable tolerance. However, where temperature measurements are desired and available for maximum accuracy in balancing they may be measured in any practical manner, including:
via a sensor mounted on the CPU, Motherboard, or Server
via a sensor mounted on our outside the computing device's case
by using data supplied by the CPU, Motherboard, energy Supply or other component of the computing device

Heat is ultimately removed from the server cabinet or rack by the CRAC and Chiller system. Thus in a further aspect of the invention, efficiencies in energy use can be increased by more closely matching the cooling operation of the CRAC units to the actual heat generated within the computer room and, more specifically, to each individual cabinet or rack. The importance of this aspect of the invention can be seen when it is appreciated that CRAC units use large amounts of energy for small changes in temperature settings—merely adjusting CRAC temperatures by just 1 degree downward costs an additional 4% in energy usage. Conventionally, data centers apply cooling according to their hottest server within a cabinet or hottest individual cabinet, and hot spots are dealt with by simply lowering the supply temperature of one or more CRAC units, resulting in substantial additional energy cost.

However when energy consumption data (heat generation data) is gathered as described above, it is possible to assign the cooling output of individual CRAC units as primary cooling sources to individual cabinets or to groups of cabinets. The heat generated within a cabinet e.g. 202 in watts can then be matched to the flow of air from each CRAC unit to increase cooling system efficiency. With the correct heat value of each cabinet, rack or equipment space, adjustable vent floor tiles and other adjustable air support structures can be used to match actual cooling wattage to each equipment rack and, thus allow each cabinet to receive the exact amount of cooling required for heat being generated in the cabinet. Other options for providing the proper cooling in wattage can include adjustable damper systems, adjustable overhead vents, and other adjustable air-flow or liquid flow devices. The objective of such systems is to manually or automatically adjust the flow of air or liquid cooling resources as measured in watts, kWh, BTU, BTU/hour or similar measurements, to match the actual power, kWh, BTU, BTU/hour or similar measurements of heat generated within a cabinet, rack, room, or other equipment space.

In addition to energy savings from matching heat generation to cooling, management of CRAC unit supply and return air temperature can provide significant energy savings since CRAC units operate more efficiently when the return air (the air arriving at the CRAC unit from the data center) is sufficiently different from the supply air (the cooled air leaving the CRAC unit). This temperature difference between supply and return is generally known as ΔT. In general, higher the spread in ΔT, the higher the efficiency. Concentrated heat loads arriving at the return air side provide a higher ΔT and therefore, higher energy efficiencies.

The use of hot-isles and cold isles is one strategy employed to concentrate heat loads to achieve a high ΔT. Other examples of heat concentration strategies include using hooded exhausts ducts at the cabinets and using cabinet-mounted CRAC units. In general, the more efficiently one is able to contain and move the exhaust heat from a cabinet to the CRAC unit, the more efficient the cooling process will be.

Ultimately the success of any such strategy can only be judged by measuring the energy used in the cooling system. Thus in a preferred form of the invention, CRAC energy usage for each CRAC unit is also monitored. It should be noted that gathering wattage data for a CRAC unit is generally not possible from a PDU as CRAC units are typically sufficiently large so as to have their own power breakers within a panel. Preferably the heat removed in BTU also monitored.

The Energy Efficiency Ratio (EER) of cooling loads can be used to determine the efficiency of each CRAC unit and chiller unit. EER is a metric commonly used for HVAC equipment. The calculation of EER for any piece of equipment is as follows:

BTUs of cooling capacity/Watt hours of electricity used in cooling

In order to maintain consistency in measurements and thus enable them to be confidently compared, it is preferable to measure both computer system energy usage and cooling system energy usage at the circuit-level within the power energy panel.

Another advantage of this arrangement is that it can be much more economical to measure circuit-level wattage in these neatly grouped units. Typically, energy panels consist of 42, 48, 84, 98 or even 100+ circuits. The ability to measure large groups of circuits from a single unit creates significant economies of scale vis-á-vis measuring circuit within a cabinet one energy strip at a time. Monitoring at the panel-level, also allows the accuracy of measurements to reach utility-grade levels while maintaining a cost that can be considerably lower than PDU strip monitoring. Highly accurate current transformers, voltage transformers and utility-grade energy meter chips can be employed.

In this preferred arrangement the energy usage data for each element of the computing and cooling system can be obtained instantaneously. In this manner each circuit's information can logically be assigned to its usage (servers within a cabinet and their users and CRAC and chiller units) via a relational database. Software accessing such a relational database can use the real-time RMS energy data for each computing resource and cooling resource in, inter alia, the following ways:
Wattage data by plug load can be measured for each server, computing device or piece of electronic equipment.
Wattage data by circuit can measured for each group of servers, computing devices or other piece of electronic equipment
Wattage data by circuit can be combined to see total heat wattage by cabinet;
Cabinet heat loads can be matched against individual CRAC unit cooling resources;
“What-if” scenarios can be employed by moving circuits virtually within a floor space to see the effect on heat and cooling efficiencies before a hard move of devices is performed;
Energy Efficiency Ratio (EER) can be seen as trends.

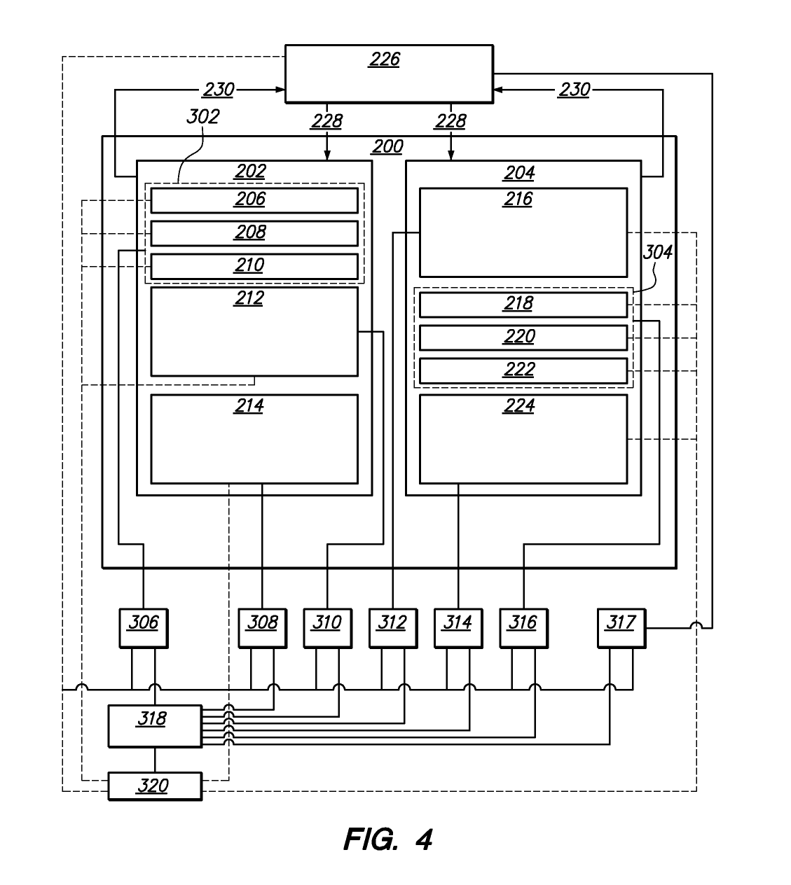

FIG. 4 illustrates a system of FIG. 3 to which circuit level energy metering for the CRAC and computing resources has been added.

In this figure, computing devices 206, 208 and 210 share a power circuit and are grouped together as device 302. Similarly computing devices 218, 220 and 222 are share a energy circuit and are referred to as computing device 304.

The actual energy used by each computing device 302, 212, 214, 216, 314 and 224 is monitored by a dedicated circuit level RMS energy monitor 306, 308, 310, 312, 314 and 316. In a preferred form the energy monitor is preferably Analog Devices 7763 energy Meter on-a-clip. The energy used by the CRAC unit 226 is similarly monitored by circuit level RMS energy monitor 317.

Each energy monitor 306, 308, 310, 312, 314, 316 and 317 is connected by a communication line (e.g. a wired or wireless data link) to a energy data acquisition system 318 such as TrendPoint Systems's EnerSure unit, in which the energy data for said circuits is stored. The energy usage data obtained by the RMS energy meters 306 to 317 is obtained instantaneously and stored in a database.

As explained above the computer load data can be used to determine the actual level of cooling that needs to be applied to the room and also where this cooling needs to be applied within the room as well as to each rack or cabinet. Thus the system includes a system controller 320 which has the task of controlling the cooling needed for each group of computing devices. Further, the system controller 320 or another system controller may be used to control the processor loads of the computing devices within the cabinets and possibly between cabinets, thus balancing the thermal resistance and/or power between individual computers or groups of computers in such a manner as to minimize cooling resources needed for said computers or group of computers. The system controller 320 accesses the database stored in energy data acquisition system 318 and uses the data for efficiency monitoring and schedules tasks or routes traffic to individual servers in accordance with a scheduling/load balancing scheme that includes attempting to match heat generation to the optimum heat profile of a cabinet (or entire room).

Because each cabinet 202 and 204 has three groups of devices e.g. 302, 212 and 214 For cabinet 212 and 216, 304 and 224 for cabinet 204, for which energy use is individually monitored the equivalent circuit for this system would include 3 resistors connected in parallel and accordingly a three zone heat balancing profile can be used.

In most current data centers each cabinet typically employ 2 circuits (whilst some bring from 3 to 4 circuits to each cabinet), this creates a natural grouping within each cabinet and to then to actively manage each grouping. Alternatively more zones and circuits can be used. The only limit is the cost and practical limitation of monitoring energy consumption on many circuits and then defining heat profiles with such a fine level of control.

The system controller 320 compares the actual energy usage data of each plug load or group of servers on a circuit to a profile of the other plug loads, and/or circuits to determine the heat load of the servers and circuits within a cabinet and then determines which are furthest in variation in comparison from one another and, therefore, from their desired heat value. The system controller 320 the uses a targeting scheduler/load balancer to send/redistribute/move processes among and between servers within separate circuits and between separate circuit within a cabinet (i.e. in different heat zones of the heat profile) in an attempt to more closely match the heat generation to the desired heat profile within the cabinet. The desired heat profile is one which shows the least variation between energy use on each circuit or between heat loads among individual servers. The process of shifting processes may focus first on virtualized servers and servers which are under the control of load balancing switches. Ideally, the system controller 320 seeks to arrange the intra-cabinet loads with a target heat variation having a standard deviation of ±10%. Inter-circuit variation can be set to a similar level or a level determined by the heat profile.

Next the operation of the cooling resources is controlled to accord with the actual measured cabinet heat loads. The system controller 320 may also automatically match the cooling provided by each CRAC unit to a server cabinet or group of cabinets. It may do this through automatically controlled floor vents or through automatically controlled fans either in or outside the CRAC unit or by automatically controlling CRAC unit temperature, or by other related means. The energy data acquisition system 118 also gather CRAC and chiller energy usage data over time and enables effects of such moves on the associated vents, fans, CRAC units and chiller units to be monitored by the system controller 320. Because the cooling effectiveness will change as the CRAC and Chillers are adjusted it may be necessary to re-balance server loads and continue to iteratively manage both processor loading and cooling system parameters. Ultimately the PUE of the entire data center can be monitored on an ongoing basis to track the effect of the changes of overall energy use over time.

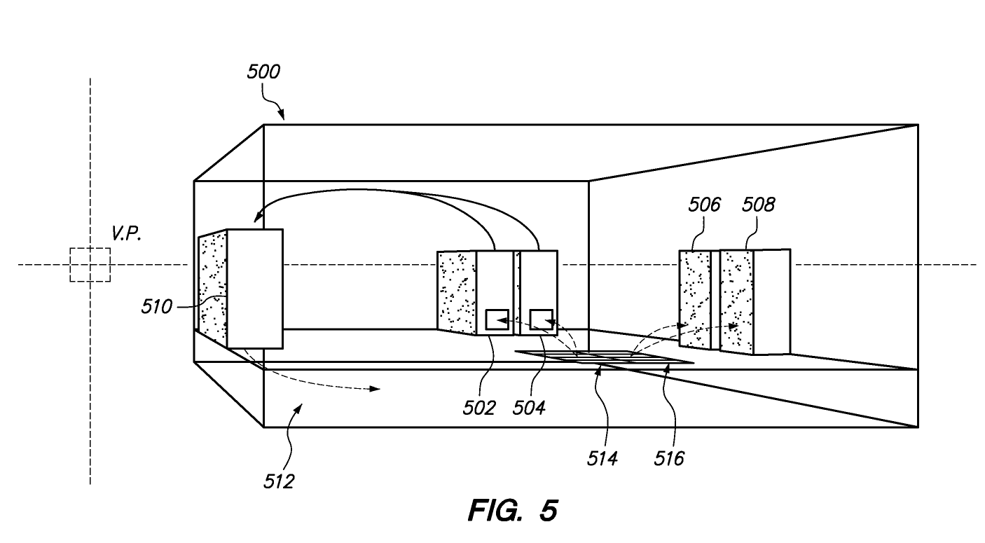

FIG. 5 illustrates a computer room 500 housing a plurality of server racks 502, 504, 506 and 508, each housing a plurality of servers. The room 500 is cooled by a CRAC 510. The computer room 500 is of a raised floor design and includes an under-floor plenum 512. During operation, the servers are cooled by air from the CRAC 510. The CRAC 510 delivers cool air to the underfloor plenum 512 as indicated by dashed arrows. This cool air is delivered to the server racks 502, 504, 506 and 508 via floor vents 514 and 516.

The air enters the racks 502, 504, 506 and 508 via respective ventilation openings on a designated side of the racks. Hot air is expelled from the server racks 502, 504, 506 and 508 via vents (not shown) located on the top of the racks. The hot air circulates through the server room 500, as indicated by solid arrows, back to the CRAC where heat is removed from the system.

In an embodiment of the present invention the operation of the CRAC 510, can be controlled, e.g. by changing temperature and flow rate, in accordance with the methods described above. Additionally the floor vents 514 and 516 can be controlled to locally control airflow direction and volume to direct cooling air onto selected servers as determined according to the methods described herein. The floor vents 514 and 516 can be manually controllable, alternatively they can be powered vents that are automatically controllable.

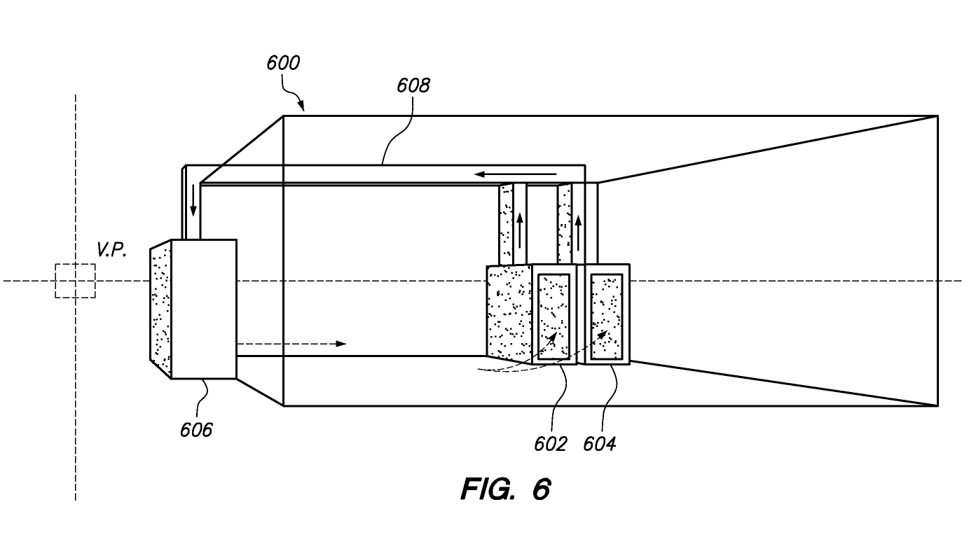

FIG. 6 illustrates a second exemplary server room able to be cooled using an embodiment of the present invention. In this system the server room 600 houses two server racks 602 and 604. The room is cooled by a CRAC 606 which delivers cool air (indicated by dashed lines) directly to the room 600. In this embodiment hot air is removed from the servers 602 and 604 via a duct system 608. The duct system 608 delivers the hot air to the CRAC 606 for cooling. In this example, the operation of the CRAC 606 and extraction fans associated with the duct system 608 can be controlled in accordance with the methods described to effectively move cooling air to the servers housed in the racks 602 and 604 and remove hot air therefrom.

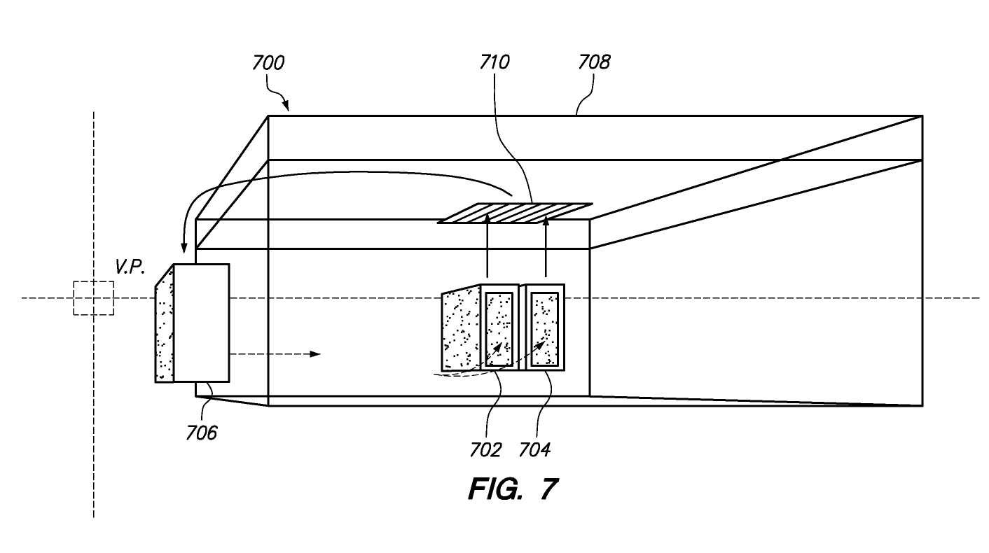

FIG. 7 illustrates a further exemplary server room able to be cooled using an embodiment of the present invention. In this system the server room 700 houses two server racks 702 and 704. The room is cooled by a CRAC 706 which delivers cool air (indicated by dashed lines) directly to the room 700. In this embodiment the room 700 includes a ventilated ceiling space 708 via which hot air is removed from the servers 702 and 704 to the CRAC 706 for cooling. Air enters the ceiling space 708 via ceiling vents 710. The ceiling vents 710 can be controlled to control the volume of cooling air entering the ceiling space 708 or to control where the hot air is removed. This can be important in controlling airflow patterns within the server room 700. The vents 708 can be manually or automatically controllable. As with the previous embodiments the operation of the CRAC 706 and the vents 710 can be controlled in accordance with the methods described above to effectively move cooling air around the system.

In these embodiments other airflow control means can also be used to direct air to particular parts of the server room, or to particular racks within the room, for example one or more fans can be used to circulate air in the room, or direct air from the underfloor plenum 512 in a particular direction; rack mounted blowers can be used for directly providing air to a rack from the plenum; and air baffles for controlling cool air delivery air circulation and hot air re-circulation can also be used to control airflow in accordance with the invention. Those skilled in the art will readily be able to adapt the methods described herein to other server room arrangements and to control other types of airflow control devices.

As will be appreciated from the foregoing, device to device variations in energy usage have been shown to be substantial. However the placement of each physical or virtual server within a rack greatly effects its heat circulation as well as the circulation patterns of nearby servers. This change in circulation patters, in turn, creates enormous differences in the amount of energy that is required to cool that server and other servers within a rack. Aspects of this invention take advantage of this property to lower cooling requirements by seeking to optimise the heat profile within each individual data cabinet. For each cabinet (or larger or smaller grouping of computing devices) a desired heat profile can be defined. The optimum heat profile for group of devices call then be used as one of many factors in the control of the computing devices. In a particularly preferred form of the invention, CPU processes, tasks threads, or any other energy using tasks can be scheduled both in time or location amongst computing devices within a cabinet, in order to most closely match the actual heat profile of the cabinet to its optimum heat profile.

1. A method of controlling energy use in a system comprising a plurality of computing resources arranged in at least one computing device, said method including;
defining a desired heat profile for a computing device which optimises airflow characteristics for the computing device;
monitoring the energy use of at lease one computing resource;
determining the heat generation of each computing resource at least partly on the basis of the energy use of the computing resource; and
controlling the operation of one or more computing resources so that the heat generation of the computing device is optimised towards the desired heat profile.

2. A method as claimed in claim 1 wherein the system includes an air conditioning system, including one or more air conditioning resources, for cooling at least one computing device, and wherein the method further includes:
controlling the operation of at least one air conditioning resource on the basis of the energy use of at least one computing resource.

3. A method as claimed in claim 2 wherein the method includes:
monitoring the energy use of at least one air conditioning resource; and
adjusting the operation of one or more computing resources so that the energy use of at least one air conditioning resource is minimised.

4. A method as claimed in claim 1 wherein the heat profile for a computing device includes one or more of:
a spatial temperature profile for the device,
a spatial temperature variation profile; and
temporal temperature variation profile.

5. A method as claimed in claim 1 wherein energy use of the computing resource is monitored on an electrical circuit powering the computing resource.

6. A method as claimed in claim 5 wherein the method includes measuring any one or more of the following parameters of the electrical circuit powering the computing resource:
electric energy flowing through the circuit;
electric energy that has flowed through the circuit in a given time;
voltage across the circuit;
current flowing through the circuit.

7. A method as claimed in claim 4 wherein the spatial temperature profile is substantially uniform.

8. A method as claimed in claim 4 wherein the temporal temperature variation profile is determined on the basis of a loading level of the computing resources comprising the computing device.

9. A method as claimed in claim 1 wherein, the step of controlling the operation of one or more computing resources so that the heat generation of the computing device is optimised towards the desired heat profile includes, controlling the operation of one or more computing resources so that electric energy flowing through a circuit powering at least two computing resources of the computing device is substantially equal.

10. A method as claimed in claim 1 wherein the step of controlling the operation of one or more computing resources includes moving at least one of the following computing tasks from one computing resource to another:
a process;
a process thread; and
a virtual server.

11. A method as claimed in claim 1 wherein the step of controlling the operation of one or more computing resources includes selectively routing network traffic to a computing resource.

12. A method as claimed in claim 2 wherein the step of controlling the operation of at least one air conditioning resource includes any one or more of the following:
selectively redirecting airflow from an air conditioning resource to cool a computing device;
adjusting an airflow level output by an air conditioning resource;
adjusting a temperature of cooling air output by an air conditioning resource.

13. A method of controlling an air conditioning system configured to cool at least one computing resource arranged in at least one computing device, said method including:
defining a desired heat profile for a computing device which optimises airflow characteristics for the computing device;
monitoring the energy use of a computing resource;
determining the heat generation of each computing resources on the basis of the energy use of the computing resource; and
controlling the operation of at least one air conditioning resource on the basis of the energy use of at least one computing resource of the computing device.

14. A method as claimed in claim 13 wherein the method includes:
monitoring the energy use of at least one air conditioning resource; and
adjusting the operation of one or more computing resources so that the energy use of at least one air conditioning resource is minimised.

15. A method as claimed in claim 14 wherein the method includes associating one or more air conditioning resources to a plurality of computing resources; and adjusting the heat removal capacity of the one or more air conditioning resources to substantially match the energy use of the computing resources with which it is associated.

16. A method as claimed in claim 15 wherein the method additionally includes
controlling the operation of one or more computing resources so that the heat generation of the computing device is optimised towards the desired heat profile.

17. A method as claimed in claim 16 wherein the heat profile for a computing device includes one or more of
a spatial temperature profile for the device,
a spatial temperature variation profile; and
temporal temperature variation profile.

18. A method as claimed in claim 13 wherein the energy use of, one or both of, an air conditioning resource or computing resource is monitored on an electrical circuit powering the resource.

19. A method as claimed in claim 18 wherein the method includes measuring any one or more of the following parameters of the electrical circuit:
electric energy flowing through the circuit;
electric energy that has flowed through the circuit in a given time;
voltage across the circuit;
current flowing through the circuit.

20. A method as claimed in claim 16 wherein the temperature profile is substantially spatially uniform.

21. A method as claimed in claim 16 wherein the step of controlling the operation of one or more computing resources so that the heat generation of the computing device is optimised towards the desired heat profile includes, controlling the operation of one or more computing resources so that electric energy flowing through a circuit powering at least two computing resources of the computing device is substantially equal.

22. A method as claimed claim 13 wherein the method includes any one or more of the following:
selectively redirecting airflow from an air conditioning resource to cool a computing device;
adjusting an airflow level output by an air conditioning resource;
adjusting a temperature of cooling air output by an air conditioning resource.

23. A computing system comprising:
a plurality of computing resources arranged in at least one computing device;
at least one automatic energy monitor adapted to measure at least one electrical parameter of a circuit powering a computing resource of the computing device;
a data acquisition sub-system for receiving a signal indicative of a measured energy parameter of the circuit powering each computing resource measured by the energy monitor; and
a controller configured to determine a level of heat generated by each computing resource on the basis of the measured electrical parameter and to control the operation of one or more computing resources so that the heat generation of the computing device is optimised towards a desired heat profile for the computing device.

24. A computing system as claimed in claim 23 wherein the system further includes:
an air conditioning system, including one or more air conditioning resources, for cooling said at least one computing device, and
wherein the controller is further configured enable the operation of at least one air conditioning resource to be controlled on the basis of a measured electrical parameter of a circuit powering at least one computing resource of the computing device.

25. A computing system as claimed in claim 24 wherein the system further includes:
at least one automatic energy monitor adapted to measure at least one electrical parameter of a circuit powering an air conditioning resource of the system.
and the data acquisition sub-system is further adapted to receive a signal indicative of said measured electrical parameter of the air conditioning resource.

26. A computing system as claimed in claim 23 wherein the heat profile for a computing device is chosen to optimise airflow to the computing device.

27. A computing system as claimed in claim 23 wherein the heat profile for a computing device includes one or more of:
a spatial temperature profile for the device,
a spatial temperature variation profile; and
temporal temperature variation profile.

28. A computing system as claimed in claim 23 wherein automatic energy monitor measures any one or more of the following parameters of the electrical circuit powering its corresponding computing or air conditioning resource:
electric energy flowing through the circuit;
electric energy that has flowed through the circuit in a given time;
voltage across the circuit;
current flowing through the circuit.

29. A computing system as claimed in claim 23 the temperature profile is substantially spatially uniform.

30. A computing system as claimed in claim 23 wherein the controller controls the operation of one or more computing resources so that electric energy flowing through a circuit powering at least two computing resources of the computing device is substantially equal.

31. A computing system as claimed in claim 23 wherein the controller enables the operation of one or more computing resources to move at least one of the following computing tasks from one computing resource to another:
a process;
a process thread; and
a virtual server.

32. A computing system as claimed in claim 23 wherein the controller enables selectively routing network traffic to a computing resource.

33. A method of distributing computing tasks between a plurality of computer resources forming at least one computer device, said method including;
defining a desired heat profile for a computing device to optimise airflow associated with the computer device;
determining the heat generation of each computing resource on the basis of the computing resource's energy use; and
adjusting the heat being generated by at least one of the plurality of computer resources to optimise the heat being generated by the computer device towards the desired heat profile by distributing computing tasks to at least one of the plurality of computer resources.

34. A method as claimed in claim 33 wherein step of distributing computing tasks includes distributing at least one of the following computing types of tasks:
a processes;
a process thread; and
virtual server.

35. A method as claimed in claim 33 wherein the step of distributing computing tasks includes selectively routing network traffic to a computing resource.

36. A method as claimed in claim 33 wherein energy use of the computing resource is determined on the basis of an parameter electrical current flowing through a circuit powering the computing resource.

37. A method as claimed in claim 36 wherein the method includes measuring any one or more of the following parameters of the electrical circuit powering the computing resource:
electric energy flowing through the circuit;
electric energy that has flowed through the circuit in a given time;
voltage across the circuit;
current flowing through the circuit.

38. A method as claimed in claim 33 wherein the temperature profile is substantially spatially uniform.

39. A method as claimed in claim 33 wherein the step of distributing computing tasks to at least one of the plurality of computer resources includes controlling the operation of one or more computing resources so that electric energy flowing through a circuit powering at least two computing resources of the computing device is substantially equal.

40. A scheduling scheme for distributing computing tasks between a plurality of computing resources of at least one computing device, said scheme being defined by a plurality of task distribution criteria relating to one or more task characteristics or computer device characteristics, wherein at least one of the task distribution criteria is at least partly based on the heat being generated by a plurality of the computing resources.

41. A scheduling scheme for distributing computing tasks between a plurality of computing resources of at least one computing device as claimed in claim 40 wherein a task distribution criteria is based upon heat value of a computing resource which is determined on the basis of a measurement of energy used by the computing resource.

42. A method of arranging one or more computing resources within a computing device forming part of a computing system; the method including;
defining a plurality of energy consumption classes and classifying the computing resources into at least one class;
defining a desired heat profile for at least part of the computing device on the basis of the energy consumption classes, said desired heat profile being configured to optimise airflow associated with the computing device;
arranging the computing resources within the computing device to optimise heat generated within the computing device towards the desired heating profile.

43. A method as claimed in claim 42 wherein the computing device is a server rack and the computing resources are servers mounted within the rack.

44. A method as claimed in claim 42 wherein the computing system is server room or data centre and the computing resources include one or more servers or other computing or network appliances.

45. A method as claimed in claim 42 wherein the plurality of energy consumption classes are defined according to heat variation of resources within the class.

46. A method as claimed in claim 42 wherein the computer resources include at least one virtual server.

47. A computing appliance configured to schedule computing tasks between a plurality of computer resources or network devices, said appliance being configured to implement the method of claim 33.

48. A system for monitoring and controlling power consumption in a computer device comprising a plurality of computing resources, the system including:
at least one automatic energy monitor adapted to measure energy use of the computing resources;
a computer system for receiving a signal indicative of a measured energy use of each computing resource measured by the energy monitor and determine a level energy consumed by each computing resource;
a controller configured to control the operation of said plurality of computing resources so as to minimise the difference in energy use between the plurality of computer resources comprising the computer system.

49. A system for monitoring and controlling power consumption in a computer device as claimed in claim 48 wherein the computer system determines which computing resource are consuming power and the rate of consumption of power.

50. A system for monitoring and controlling power consumption in a computer device as claimed in claim 48 wherein the controller enables manual management the rate of power consumption.

51. A system for monitoring and controlling power consumption in a computer device as claimed in claim 48 wherein the controller automatically manages the the rate of power consumption.

52. A system for monitoring and controlling power consumption in a computer device as claimed in claim 48 wherein the energy use of each computing resource is monitored by a dedicated automatic energy monitor.

53. A system for monitoring and controlling power consumption in a computer device as claimed in claim 48 wherein the energy use of a plurality of computing resources is monitored by a common automatic energy monitor.

54. A system for monitoring and controlling power consumption in a computer device as claimed in claim 48 wherein the controller minimises the difference in energy use between the plurality of computer resources comprising the computer system by controlling the processes running on each computing device

55. A system for monitoring and controlling power consumption in a computer device as claimed in claim 48 wherein the controller enables control of the computing device remotely from the computing device.

56. A system for monitoring and controlling power consumption in a system comprising a computer device including a plurality of computing resources and at least one cooling device for cooling the computing device, the system including:
at least one automatic energy monitor adapted to measure energy use of the computing resources and the cooling device;
a computer system for receiving a signal indicative of a measured energy use of each computing resource and cooling device as measured by the energy monitor and to determine a level energy consumed by each computing resource and cooling device;
a controller configured to control the operation of at least one of said computing resources and cooling devices to control the amount of cooling being used by each computing device at least partly on the basis of the measured energy use of at least one of said computing resources and cooling devices.

57. A system as claimed in claim 56 wherein the controller enables manual control of the operation of at least one of said computing resources and cooling devices to control the amount of cooling being used by each computing device.

58. A system as claimed in claim 56 wherein the controller enables manual control of the operation of at least one of said computing resources and cooling devices to match the rate of cooling to the energy consumption of each computer device.

59. A system as claimed in claim 56 wherein the controller automatically controls the operation of at least one of said computing resources and cooling devices to control the amount of cooling being used by each computing device.

60. A system as claimed in claim 56 wherein the controller automatically controls the operation of at least one of said computing resources and cooling devices to match the rate of cooling to the energy consumption of each computer device.
